(19) United States
(12) Patent Application Publication
(10) Pub. No.: US 2007/0191060 A1
(43) Pub. Date: Aug. 16, 2007

(54) Method and device for distinguishing selected line information among multi line information providing alternate line service

(75) Inventor: Ji-Young Baek, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/586,382

(22) Filed: Oct. 25, 2006

(30) Foreign Application Priority Data
Feb. 10, 2006 (KR) 2006-13296

(51) Int. Cl. H04B 1/38

(52) U.S. Cl. 455/558

(57) ABSTRACT

A device and method for distinguishing selected line information among multi line information providing ALS (alternate line service). The device includes an SIM (subscriber identity module) for storing the selected line information among the multi line information providing the ALS service, in a file for storing support information of a CSP (customer service profile) on a data structure; and an ME (mobile equipment) for, upon insertion of the SIM, determining if the ALS service is supported from the SIM, and upon determining that the ALS service is supported, acquiring the selected line information from the file, and executing the ALS service based on the acquired line information.

### PRIORITY

This application claims priority under 35 U.S.C. § 119 to an application entitled “Method and Device for Distinguishing Selected Line Information among Multi Line Information Providing ALS Service” filed in the Korean Intellectual Property Office on Feb. 10, 2006 and assigned Serial No. 2006-13296, the contents of which are incorporated herein by reference.

### BACKGROUND OF THE INVENTION

1. Field of the Invention

The present invention relates generally to a method and device for distinguishing selected line information among multi line information providing an alternate line service (ALS) irrespective of a type of a subscriber identity module card.

2. Description of the Related Art

In recent years, with the popularization of a mobile communication terminal, various services such as wireless Internet service and positioning service provide a variety of information to a user of a mobile communication terminal and are being provided following the transmission of a basic voice call, and character and voice messages.

Among them, in a global system for mobile communication (GSM) method used for European mobile equipment (ME: mobile communication terminal other than SIM), additional services that are selected after consulting with service providers is provided. The additional service defined in the GSM method referred to as “common Personal Communication Network (PCN) handset specification (CPHS)”. This is a service defined after consulting with several service providers other than England ORANGE service provider. Accordingly, the user can be provided with an interface facilitating an easy use of the ME, using the various services defined in the CPHS, without a need to distinguish whether a network is managed by a particular service provider.

Among several functions of the CPHS, CSP function is a service where a user subscription additional service is stored and managed in a subscriber identity module (SIM), thereby improving a conventional method where a mobile communication network is inquired and checked for additional service subscription every time.

During the execution of the CSP function, alternate line service (ALS) subscription is also managed together. This ALS service refers to a function of providing two mobile station identity subscriber directory numbers (MSISDNs) to one international mobile subscriber identity (IMSI).

The GSM method used for the European ME uses the SIM card. The SIM card is a smart card detachable from the ME. The SIM card includes a microprocessor and a memory chip, and stores a variety of information of a SIM card user.

An example of the information stored in the SIM card are line information for providing two MSISDNs of the ALS service. Here, one line is assigned to each MSISDN. The user can select any one line as a main line, and use a desired MSISDN. Specifically, the SIM card provided by the ORANGE service provider has a file (EF_{dynamic}_{_{—}}_{flags}) among the data structure of the SIM. The file stores the line information currently assigned to the ME. In other words, the line information representing whether the ME is set is made through any one of line1 and line2 and is stored to the file (EF_{dynamic}_{_{—}}_{flags}).

However, in remaining SIM cards excepting the SIM card provided by the ORANGE service provider, the file (EF_{dynamic}_{_{—}}_{flags}) does not exist in the SIM cards. Thus, most MEs cannot choose but to store the selected line information in nonvolatile RAMs. In other words, the selected line information cannot be stored in the SIM card inserted into the ME and therefore, when the user inserts the current SIM card into a different ME, the selected line information stored in a previous ME is not maintained.

As described above, in a conventional technology supporting the ALS service, there is not a standardized specification necessary to check whether the ME is currently set to line1 or line2. Accordingly, in a method for storing the line information for supporting the ALS service in the file (EF_{dynamic}_{_{—}}_{flags}) the SIM card having the data structure without the file (EF_{dynamic}_{_{—}}_{flags}) cannot support the ALS service. In the method for storing the selected line information in the RAM of the ME, when the user changes the ME into which the SIM card is inserted, the selected line information stored in the previous ME is not maintained.

### SUMMARY OF THE INVENTION

It is, therefore, an aspect of the present invention to provide a method and device for distinguishing selected line information among multi line information providing ALS service irrespective of a type of a subscriber identity module card.

To achieve the above and other aspects, there is provided a device for distinguishing selected line information among multi line information providing ALS (alternate line service). The device includes an SIM (subscriber identity module) for storing the selected line information among the multi line information providing the ALS service, in a file (EF_{CSP}) to store support information of a CSP (customer service profile) on a data structure; and an ME (mobile equipment) for, upon insertion of the SIM, determining if the ALS service is supported from the SIM, and upon a determination that the ALS service is supported, acquiring the selected line information from the file, and executing the ALS service based on the acquired line information.

In another aspect of the present invention, there is provided a method for distinguishing selected line information among multi line information providing ALS (alternate line service), in a device having an SIM (subscription identity module) and a mobile equipment (ME). The method includes upon insertion of the SIM, checking a file (EF_{CSP}) to store support information of a CSP (customer service profile) on a data structure of the SIM; checking the file to determine if the ALS service is supported, and when the ALS service is supported, acquiring the selected line information among the multi line information providing the ALS service, from the file; and executing the ALS service depending on the acquired line information.

### BRIEF DESCRIPTION OF THE DRAWINGS

The above and other aspects, features and advantages of the present invention will become more apparent from the following detailed description when taken in conjunction with the accompanying drawings in which:

FIG. 1 illustrates a construction of a device for distinguishing line information according to the present invention;

FIG. 2 illustrates a data structure of a subscriber identity module (SIM) according to the present invention;

FIG. 3 illustrates a detailed structure of a file (EF_{CSP}) to store support information of a customer service profile (CSP) of FIG. 2;

FIG. 4 is a flowchart illustrating a method for distinguishing selected line information among multi line information providing ALS service according to the present invention; and

FIG. 5 is a flowchart illustrating a method for updating and storing line information according to the present invention.

### DETAILED DESCRIPTION OF THE PREFERRED EMBODIMENT

A preferred embodiment of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

The present invention distinguishes selected line information among multi line information providing alternate line service (ALS) irrespective of a type of a subscriber identity module (SIM) card. For this, in the present invention, the selected line information can be set to a specific file relating to a customer service profile (CSP) on a common data structure of all the SIMs supporting the ALS. Thus, the SIM being inserted, a mobile equipment (ME) determines if the SIM supports a common PCN handset specification (CPHS). The SIM supporting the CPHS, the ME determines if it subscribes to the ALS service. Subscribing to the ALS service, the ME checks a specific field relating to the ALS service, and checks if there is a setting to a particular line. According to the present invention, the line information can be easily distinguished by overcoming a limitation of a type of the SIM. Thus, even though the ME is replaced, the line information for using the ALS service is kept in the SIM. Therefore, a user can use the ALS service is any phone.

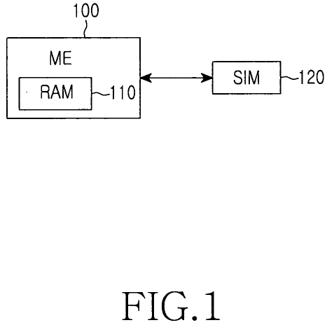

In a device for distinguishing the selected line information, its constituent element and operation will be described with reference to FIG. 1. FIG. 1 illustrates the device for distinguishing the line information according to the present invention.

Referring to FIG. 1, the line information distinguishing device according to the present invention mainly includes the ME 100, and the SIM 120 inserted into the ME 100.

Upon the insertion of the SIM 120, the ME 100 checks if the SIM 120 supports the CPHS. If so, the ME 100 checks if the ALS service, one of additional services of the CPHS, is supported. If the user subscribes to the ALS service and is supported by the ALS service, the ME 100 checks if a setting is made to any one of a multi line providing the ALS service. Accordingly, the ME 100 performs the ALS service using the checked line.

For a detailed description, a case where the user selects a line1 as a main line and stores it in the SIM 120 will be exemplified.

Once the ALS service is supported, the user has two telephone numbers. An outgoing call is made using a line currently set. In this case, subscribing to a caller identification service, a called party ME displays on its screen a mobile station identity subscriber directory number (MSISDN) corresponding to the line currently set by the user, that is, line1.

On contrary, an incoming call can be made to all two multi lines irrespective of the line set by the user. However, the ME 100 displays on its screen whether the incoming call is made to any line. In other words, at the time of the incoming call, the ME 100 can display on the screen to the user that the incoming call is made to line1.

As described above, the ME 100 has to recognize whether the setting is made to any line so as to inform the called party ME that the outgoing call is made to a particular line or inform the user that the incoming call is made to a particular line. For this, according to the present invention, the ME 100 should access the SIM 120 and check if the setting is made to a line. Thus, the ME 100 reads the selected line information upon the insertion of the SIM 120.

The ME 100 reads the selected line information from the SIM 120 and then, stores the read information in a random access memory (RAM) 110. The ME 100 assigns a global variable to temporarily store the selected line information, and stores it. The user changing current line information, the ME 100 again stores the changed line information in the global variable. After that, when the inserted SIM 120 is removed from the ME 100, the ME 100 provides the line information stored in the global variable, to the SIM 120. Thus, a file in which the selected line information is stored in the SIM 120 is changed.

The SIM 120, a smart card module inserted into the European ME 100 and authenticating a mobile communication network, can implement nonvolatile data storage such as a user subscription service provider and a private telephone directory, and restricted password function and software execution, for example. The SIM 120 stores telephone numbers, a private security key, and data necessary to operate the ME. Therefore, even though the SIM 120 is inserted into a new ME out of the ME 100 that is now in use, its information can be used as it is. This is common and used in the mobile communication network and therefore, its detailed description will be omitted.

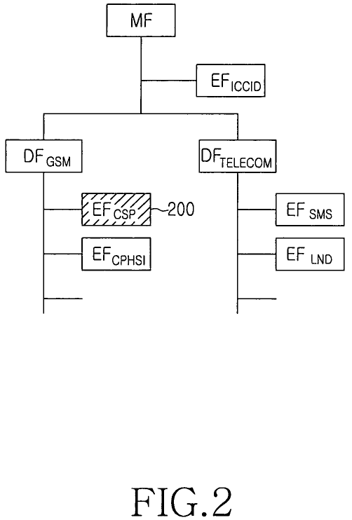

The SIM 120 stores information for the operation of the ME 100 by a data structure based on a file format. FIG. 2 illustrates the data structure of the SIM according to the present invention.

The multi line information providing the ALS service is stored in a file (EF_{CSP}) 200 storing support information of a conventional CSP without separate file addition. Thus, the multi line information, which at one time could have only been provided in a specific SIM, can now be set to a common file, thereby not only effectively utilizing a storage space of the SIM but also allowing the user to easily use the ALS service irrespective of a type of the SIM. Moreover, the present invention uses the data structure of the SIM without any changes and thus, even though the user replaces the ME, it is possible to use the information stored in the SIM, without change.

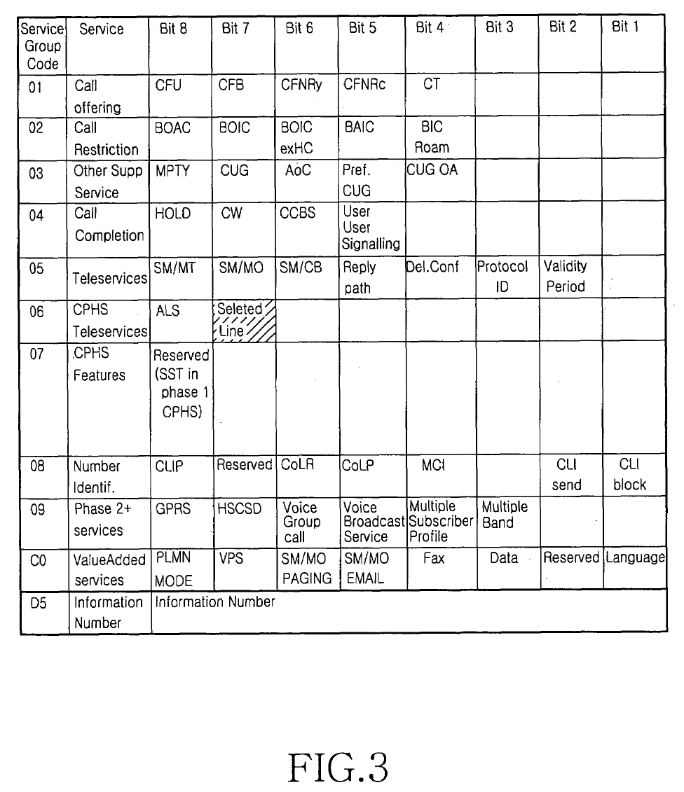

FIG. 3 illustrates a detailed structure of the file (EFcsp) used to store the support information of the CSP of FIG. 2.

Referring to FIG. 3, information indicating ALS service support is set to a “Bit 8” of a common PCN handset specification (CPHS) teleservices field where a service group code is “06”. A “Bit 7” of the CPHS teleservices field is used for setting the selected line information. For example, any one of a value of 1 indicating the line1 and a value of 0 indicating a line2 can be set to the “Bit7”. Accordingly, the ME 100 can check the CPHS teleservices field in the file (EF_{CSP}) 200 storing the support information of the CSP of the SIM 120, and read the information on the ALS service support and the selected line information. When a code value of the CPHS teleservices field is “C0” based on a hex value, the ME 100 recognizes that the SIM 120 supports the ALS service while being set to line1. When the code value, which is read from the SIM card 120, of the CPHS teleservices field is “08”, the ME 100 recognizes that the SIM 120 supports the ALS service while being set to line2 for providing the ALS service.

FIG. 3 illustrates that the selected line information is set to the “Bit 7” of the CPHS teleservices field, but it is a mere example and does not intend to limit the present invention. In other words, it is of course contemplated that the selected line information can be set to a reserved Bit among defined fields other than the CPHS teleservices field of the file (EF_{CSP}) 200 storing the support information of the CSP. However, in FIG. 3, the selected line information is set to the Bit adjacent to a Bit indicating the ALS service support or not in order to show a relationship with the ALS service.

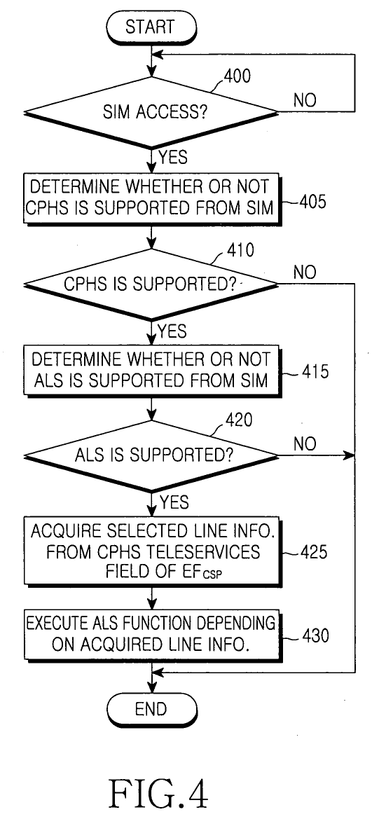

FIG. 4 is the flowchart illustrating the method for distinguishing the selected line information among the multi line information providing the ALS service according to the present invention.

First, the ME 100 determines if the SIM 120 is inserted and SIM 120 access is possible in Step 400. If the SIM 120 is inserted and the SIM access is possible, the ME 100 determines if the SIM 120 supports the CPHS in Step 405. For this, the ME 100 checks a file (EF_{CPHS1}) storing support information of the CPHS in the data structure of the SIM 120. On the basis of the file check result, the ME 100 determines if the CPHS is supported in Step 410. If the determination result is that the CPHS is supported, the ME 100 determines if the ALS service is supported in Step 415. For this, the ME 100 checks the file (EF_{CSP}) storing the support information of the CSP in the data structure of the SIM 120. On the basis of the file check result, the ME 100 determines if the ALS service is supported in Step 420. If the determination result is that the ALS service is supported, the ME 100 reads a code value of the CHPS teleservices field of the file (EF_{CSP}) storing the support information of the CSP, and acquires the selected line information in Step 425. And then, the ME 100 performs an ALS service function depending on the acquired line information in Step 430.

Through a procedure described above, the ME 100 can easily acquire the selected line information among the multi line information providing the ALS service, by the user from the SIM 120. Accordingly, even though the user inserts the SIM into a new ME, the line information stored in the SIM is kept as it is and thus, it is possible for the new ME to stably determine the line information for using the ALS service.

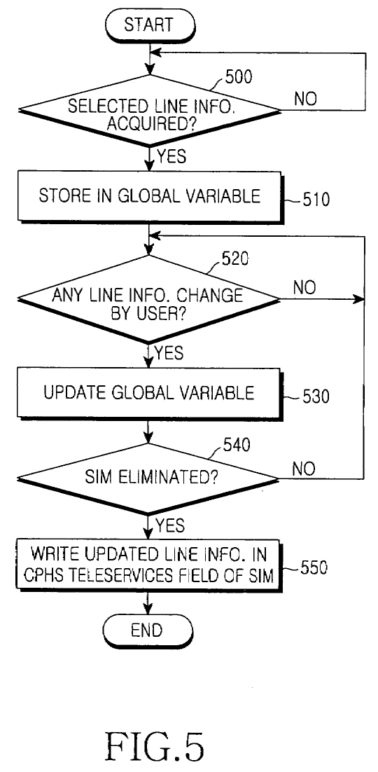

The user can change the setting of any one line as the main line, using the ALS service by two telephone numbers. An operation of the ME 100 depending on the setting change will be described with reference to FIG. 5. FIG. 5 is a flowchart illustrating a method for updating and storing the line information according to the present invention.

Once the SIM 120 is inserted, the ME 100 checks files necessary to execute its operation in the SIM 120. In particular, according to the present invention, the procedure of FIG. 4 is executed to provide the ALS service. In Step 500, the ME 100 determines if the selected line information used in the present invention is acquired. If the determination result is that the selected line information is acquired, the ME 100 temporarily stores the acquired line information in the global variable in Step 510. Accordingly, the ME 100 can display an MSISDN of the line currently set, on its screen at the time of the incoming call, and can also allow an MSISDN of its set line, to be displayed on a screen of the called party ME at the time of the outgoing call.

While the ME 100 executes the ALS service as above, the ME 100 determines if there is line information change by the user in Step 520. If the determination result is that the line information changes, the ME 100 stores the changed line information in the global variable in which previous line information is stored, and updates the global variable in Step 530. After that, the ME 100 determines if the SIM 120 is eliminated in Step 540. The SIM 120 being eliminated, the ME 100 proceeds with Step 550, and writes the updated line information in the CHPS teleservices field of the SIM 120. As such, when the SIM 120 is eliminated, the ME 100 transmits and stores the updated line information in the SIM 120.

According to the present invention, the selected line information is stored in a general SIM, not in a SIM of a specific service provider, using the common SIM data structure, thereby making it possible to stably provide the ALS service. Further, even though the SIM is inserted into the called party ME, not the user ME, the user can use the ALS service as it is, even using the called party ME. Furthermore, in the present invention, a conventional SIM data structure is utilized, thereby efficiently utilizing the storage space of the SIM.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A device for distinguishing selected line information among multi line information providing ALS (alternate line service), the device comprising:
an SIM (subscriber identity module) for storing the selected line information among the multi line information providing the ALS service, in a file for storing support information of a CSP (customer service profile); and
an ME (mobile equipment) for, upon insertion of the SIM, checking if the ALS service is supported from the SIM, and upon a determination that the ALS service is supported, acquiring the selected line information from the file, and executing the ALS service based on the acquired line information.

2. The device of claim 1, wherein the SIM supports a common Personal Communication Network (PCN) handset specification (CPHS).

3. The device of claim 1, wherein the selected line information is set to a specific bit of a CPHS teleservices field of the file storing the support information of the CSP.

4. The device of claim 1, wherein the selected line information is set to a reserved bit of a specific field of the file storing the support information of the CSP.

5. The device of claim 1, wherein the ME stores the line information acquired from the SIM, in the global variable, and updates and stores the global variable whenever a user changes the line information.

6. The device of claim 5, wherein, when the SIM is removed, the ME provides to the SIM the line information stored in the global variable.

7. The device of claim 1, wherein, if there is an incoming call, the ME displays a mobile station identity subscriber directory number (MSISDN) corresponding to the acquired line information, among two MSISDNs provided in the ALS service.

8. The device of claim 1, wherein, if there is an outgoing call, the ME provides the acquired line information so that an MSISDN corresponding to the acquired line information among two MSISDNs provided in the ALS service is displayed on a screen of a called party ME in which a caller identification service is possible.

9. A method for distinguishing selected line information among multi line information providing ALS (alternate line service), in a device having an SIM (subscription identity module) and a mobile equipment (ME), the method comprising steps of:
upon insertion of the SIM, searching for a file for storing support information of a CSP (customer service profile);
checking the file to determine if the ALS service is supported, and when the ALS service is supported, acquiring the selected line information among the multi line information providing the ALS service, from the file; and
executing the ALS service depending on the acquired line information.

10. The method of claim 9, further comprising:
upon the insertion of the SIM, determining if a CPHS (common PCN handset specification) is supported; and
when the CPHS is supported, checking the file.

11. The method of claim 9, wherein the selected line information is set to a specific bit of a CPHS teleservices field of the file storing the support information of the CSP.

12. The method of claim 9, wherein the selected line information is set to a reserved field of a specific field of the file storing the support information of the CSP.

13. The method of claim 9, further comprising:
storing the line information acquired from the SIM, in a global variable; and
whenever there is line information change by a user, updating and storing the global variable.

14. The method of claim 13, further comprising, when the SIM is removed, providing the line information stored in the global variable, to the SIM.

15. The method of claim 9, further comprising:
determining if there is an incoming call; and
if the determination result is that there is the incoming call, displaying a mobile station identity subscriber directory number (MSISDN) corresponding to the acquired line information among two MSISDNs provided in the ALS service, on a screen.

16. The method of claim 9, further comprising:
determining if there is an outgoing call by a user; and
when there is the outgoing call, providing the acquired line information so that an MSISDN corresponding to the acquired line information among two MSISDNs provided in the ALS service is displayed on a screen of a called party mobile equipment in which a caller identification service is possible.
